(19) United States
(12) Patent Application Publication
(10) Pub. No.: US 2018/0322490 A1
(43) Pub. Date: Nov. 8, 2018

(54) METHOD FOR THE HANDLING OF A FREIGHT CONTAINER

(71) Applicant: Thales Management & Services Deutschland GmbH, Ditzingen (DE)

(72) Inventors: Yves Sterbak, Hochdorf (DE); Florian Tolksdorf, Brechen (DE); Dragan Ivankovic, London (GB); Martin Tolksdorf, Brechen (DE); Mario Galatovic, Bretten-Rinklingen (DE); Abhay Tiple, Stuttgart (DE); Phillip Groeting, Ludwigsburg (DE)

(21) Appl. No.: 15/965,761

(22) Filed: Apr. 27, 2018

(30) Foreign Application Priority Data
May 2, 2017 (DE) 10 2017 207 345.4

(51) Int. Cl. G06Q 20/38; G06Q 30/04; G06Q 10/08; G06Q 30/06

(52) U.S. Cl. CPC G06Q 20/3823; G06Q 30/0601; G06Q 10/0835; G06Q 30/04

(57) ABSTRACT

A method for the handling of a freight container that is transported from a sender via a carrier to a recipient includes an electronic bill of lading generated by a secured generator module and stored in encrypted form on a central secure server. The sender and the recipient receive an electronic key. The carrier can electronically request decrypted parts of the electronic bill of lading via a data connection. If the recipient is satisfied with the freight container received he transmits his key electronically to the central secure server. The sender electronically transmits his key to the central secure server when he wishes to release the bill of lading. The encrypted electronic bill of lading can be decrypted on the central secure server using the two keys and the decrypted electronic bill of lading is electronically transmitted to the recipient. The transfer of ownership to the recipient is thereby completed.

### CROSS-REFERENCE TO RELATED APPLICATIONS

This application claims priority to German Patent Application No. 10 2017 207 345.4, filed May 2, 2017, the entire contents of which are hereby incorporated by reference.

### DESCRIPTION

### Field of the Invention

The invention relates to a method for the handling of a freight container, which is sent from a sender via one or more carriers to a recipient.

### Background of the Invention

Freight containers are used to transport all types of goods. Such containers can in particular be moved between different locations on ships, trucks or railway trains. Freight containers that meet the requirements of the standards laid down by the International Maritime Organization (IMO), such as ISO 668, are particularly widespread.

The transport of a freight container from a sender (for example a manufacturer which has filled the goods into the container) to a recipient (for example the purchaser of the goods in the freight container) generally involves the participation of at least one carrier (for example a shipping company, a forwarding agent or a railway company). A bill of lading is issued for the freight container in this process. This bill of lading enables the person who possesses it to demonstrate that he is entitled to take possession of the contents of the container (and for example to sell the contents on or process them further). In contrast thereto the carrier or carriers shall be entitled merely to transport the contents further, but not to take possession of the contents.

In the state of the art, the bill of lading is issued as a paper document. To prevent carriers from taking possession of the contents of a freight container without authorization they are given only a copy of the bill of lading for the transport. Each carrier requires a further document that shows that he is authorized to further transport the goods.

After it has been issued the original of the bill of lading is in most cases deposited with a bank which acts as an intermediary between the sender and the recipient. Once the recipient has received the freight container and checked its contents he typically pays the agreed purchase price to the bank. The bank then forwards the bill of lading to the recipient and transfers the purchase price to the sender. The process is very time-consuming and the involvement of the bank means that considerable costs are incurred.

It is also known for the original of the bill of lading to be sent together with the freight container. With this approach, however, there is the fundamental danger of unauthorized access to the bill of lading. In particular, there is the possibility of a further sale of the freight container or its contents using a wrongfully obtained bill of lading. The carriers should therefore keep the bill of lading particularly safe, which can give rise to considerable costs. Moreover, the carriers must be granted authority to transport the bill of lading further, which typically requires further authorization, typically coupled with a further separate legitimation document.

Overall, therefore, the handling of a freight container upon transport with respect to the bill of lading is a complex matter, and is in particular time-consuming and expensive.

### SUMMARY OF THE INVENTION

The object of the invention is to simplify the exchange of goods through freight containers and in particular to speed up the process and to reduce costs.

This object is achieved through a method for the handling of a freight container, that is transported from a sender via one or more carriers to a recipient, with the following steps:

A sender provides a freight container, and a transport plan is prepared for the freight container and stored on a central administration server, wherein the transport plan lists at least the sender, one or more carriers and the recipient of the freight container;

An encrypted electronic bill of lading is prepared using a secured generator module, wherein the encrypted electronic bill of lading can only be fully decrypted through the joint use of a first key and a second key, and wherein parts of the encrypted electronic bill of lading can be decrypted without the two keys;

The encrypted electronic bill of lading is transmitted to a central secure server and is stored on that central secure server, and the first key is transmitted to the sender of the freight container and the second key is transmitted to the recipient of the freight container;

The freight container is transported via one or more carriers to the recipient, wherein

a. Each carrier authenticates against the central administration server and requests a decrypted part of the bill of lading from the central secure server;
b. And if a check of the central administration server shows that the carrier is envisaged in the stored transport plan of the freight container then a decrypted part of the bill of lading is transmitted to the carrier, by means of which the carrier can demonstrate that he is authorized to further transport the freight container;

The recipient checks the freight container, and if the recipient decides to accept it then the recipient authenticates against the central administration server and transmits the second key to the central secure server;

If the sender decides to release the freight container for the recipient then the sender authenticates against the central administration server and transmits the first key to the central secure server;

If the second key in step e) and the first key in step f) have been transmitted to the central secure server, the encrypted electronic bill of lading stored on the central secure server is decrypted completely by means of these keys, and the completely decrypted electronic bill of lading is transmitted to the recipient of the freight container, by means of which the recipient can demonstrate his entitlement to take possession of the contents of the freight container.

Within the scope of the present invention the document management for the transport of a freight container and/or during the transport procedure of a freight container is simplified. In particular, the bill of lading, by means of which the person possessing it can demonstrate that he is authorized to take possession of the contents of the freight container, or to exploit them, is handled as an electronic bill of lading.

This enables document management to be largely digitalized and the bill of lading to be electronically accessed via data lines. Electronic access to the electronic bill of lading accelerates and simplifies procedures. This largely dispenses with the need to prepare, send out, hand over and guard paper documents.

The encryption measures for the electronic bill of lading according to the invention can increase the security of the goods exchange and bring about a simplification in the course of the document handling and freight container handling.

Within the scope of the invention an original (at least) two-sided electronic encryption of the bill of lading is used, through which any premature unauthorized access to the bill of lading can be avoided. On the other hand, the distribution of the two keys between the sender and the recipient means that the sender and the recipient can pursue the decryption of the bill of lading and thus the release of the freight container to the recipient substantially on their own. In particular, the interim storage of an original bill of lading at a bank and the delivery of the original bill of lading by the bank is no longer necessary.

The electronic bill of lading is initially generated in encrypted form using a secured generator module; the first and second keys are similarly prepared, which are necessary for the complete decryption of the encrypted electronic bill of lading. Therefore, on the generator module, corresponding hardware is installed and software stored. The secured generator module is protected against manipulations through suitable measures. Typical security measures encompass a fully closed, in particular armor-plated casing, mechanical or electronic locks on casing entry points and automatic self-destruct or self-deleting mechanisms upon detection of unauthorized manipulations; on the software side multistage password protections are mostly used and encrypted data transmission connections are set up.

The encrypted electronic bill of lading is stored on the central secure server; the central secure server may also hold a back-up copy where necessary; otherwise there is usually no further storage of the encrypted electronic bill of lading. The central secure server (also referred to as a “secured safe”) is typically located in a guarded building to which the public has no access and on the software side is protected against unauthorized access by suitable measures, in particular through firewalls and password controls. The first key is transmitted to the sender, typically under intermediation of the central administration server which has information on the sender in the transport plan, and is stored by the sender; otherwise there is usually no further storage of the first key. The second key is similarly transmitted to the recipient, typically under intermediation of the central administration server which has information on the recipient in the transport plan, and is stored by the recipient; otherwise there is usually no further storage of the second key.

To simplify the transport process, parts of the bill of lading may in accordance with the invention be requested and read out without decryption, in particular those parts that are necessary for legitimation of the carriers. A carrier, which requires a part of the bill of lading for his legitimation, merely needs to authenticate against the central administration server via a data line and then receives (provided he is listed in the transport plan as having this role) a corresponding file via the data connection which he can display on an end device and/or print out if necessary. It is not necessary to hand over or send paper documents to the carrier. Similarly, inspectors (for instance the customs authorities of a country in which the freight container is being transported) are given access to parts of the bill of lading. Access to the complete bill of lading, which would provide entitlement to the ownership of the contents of the freight container, is however not possible without both keys.

Once the freight container has arrived with the recipient (listed in the transport plan/bill of lading), the recipient can check the condition of the freight container and/or its contents, for example the completeness of the goods inside or the correct condition of the goods. Where necessary, the recipient (similarly to the carrier) under his authentication against the central administration server can request an unencrypted part of the bill of lading, to legitimize himself for the checking of the contents of the freight container. If the recipient wants to accept the freight container/its contained goods then he transmits his second key to the central secure server. Typically, the recipient then also pays the agreed purchase price (usually to the sender directly, or if desired for security reasons to a fiduciary). Then it is the turn of the sender. If he wants to release the contents of the freight container for the recipient, typically when confirmation is provided that the purchase price has been paid (either to himself or to the fiduciary), then he also transmits his first key to the central secure server. The central secure server is then in a position to decrypt the encrypted electronic bill of lading and to transmit it to the recipient via a data line. As the owner of the completely decrypted bill of lading, which the recipient typically prints out, the recipient then has the legitimation to exploit the goods in the freight container, and in particular to remove them from the freight container and to sell them on or process them further.

Preferred variants of the invention:

With a preferred variant of the method according to the invention the secured generator module authenticates the electronic bill of lading upon its preparation, clearly labels it and encrypts it. Within the course of the authentication procedure information is entered in the bill of lading by means of which its authenticity can be confirmed (or refuted), for example an alphanumeric authentication code which follows certain (secret) compilation principles. Unequivocal identification can similarly be achieved by means of an alphanumeric code, in most cases this contains a sequential component and a component that identifies the_preparing secured generator module. The encryption means that the content of the bill of lading is at least in part hidden (made unrecognizable), typically by means of a mathematical conversion of the underlying data, using both of the keys. The stated measures increase security when using the electronic bill of lading.

Similarly preferred is a variant in which the respective carrier in step d) receives in addition to the part of the bill of lading also a part of the stored transport plan, in particular information on a prior carrier and/or a next carrier and/or handover times and/or handover locations. The (partial) access to the transport plan can simplify the handling of the freight container for the carrier or increase security. The carrier can establish from secure sources that he receives the freight container from the correct previous carrier and hands it to the correct subsequent carrier. The centrally-stored transport plan enables ready updating of the data, for instance upon transport delays.

Of particular advantage is a variant in which the encrypted electronic bill of lading after its transmission to the central secure server in step c) is removed from the secured generator module. The encrypted electronic bill of lading is then only stored on the central secure server. As a result the (encrypted) bill of lading is particularly secure, in particular the danger of unauthorized access to the (encrypted) bill of lading on the secured generator module is minimized. Removal (deletion) can follow directly after successful transmission to the central secure server.

Also of particular advantage is a variant in which the first and second keys after their transmission in step c) are removed from the secured generator module and where applicable also from the central administration server. The first key is then stored only by the sender of the freight container, and the second key only by the recipient of the freight container. This also means that the (encrypted) bill of lading is especially secure, in particular the danger of unauthorized access to the keys at the secured generator module or at the central administration server is minimized. The removal (deletion) can directly follow successful transmission to the sender and recipient. The keys are deleted from the central administration server if in step c) the first and second keys are transmitted from the secure generator module firstly to the central administration server, and then the first key is transmitted via the central administration server to the sender and the second key is transmitted via the central administration server to the recipient.

Of further advantage is a variant in which the electronic bill of lading after its complete decryption and transmission to the recipient in step g) is deleted from the central secure server. The electronic bill of lading is then only available to the recipient. This minimizes the danger of an unauthorized repeated access to the (encrypted or decrypted) bill of lading on the central secure server. Deletion can immediately follow the successful transmission of the decrypted bill of lading to the recipient.

With a preferred variant for the preparation of the encrypted electronic bill of lading the secured generator module receives information from the transport plan stored on the central administration server. In so far as information from the central administration server can be made available via a data line at the secured generator module, this information does not need to be established and entered (manually entered, for instance) otherwise. At the same time, any inconsistencies between the bill of lading and the transport plan are avoided.

Especially preferred is a variant which provides that the stored transport plan of the freight container or the central administration server lists at least one inspector for a number of transport plans, including the stored transport plan of the freight container, that during step d) an inspector authenticates against the central administration server and requests a decrypted part of the bill of lading, and that if a check of the central administration server shows that the inspector is envisaged in the stored transport plan of the freight container or in the central administration server for a large number of transport plans, including the stored transport plan of the freight container, then a decrypted part of the bill of lading is to be transmitted to the inspector. The electronic access for an inspector, for instance a customs authority, set up in this variant, enables controls to be simplified and accelerated. In particular, it is not necessary to keep any paper documents ready for the inspector and to pass them to him. Furthermore, a control process, for example for customs clearance, can be commenced before a carrier of the freight container arrives at the premises of the inspector with paper documents.

In a preferred further development of this variant, following transmission of the decrypted part to the inspector the existing electronic bill of lading for the freight container is deleted and is replaced for the further method by a new electronic bill of lading for the freight container, which is stored in encrypted form on the central secure server, wherein for the new encrypted electronic bill of lading a new first key is transmitted to the sender and a new second key is transmitted to the recipient. The inspector is typically a customs office, which typically requires a large amount of information from the bill of lading. Thereafter, the security of the freight container transport can be improved by the preparation of a new bill of lading. Similarly, the inspector can, before the preparation of a new (encrypted) bill of lading, pass information to the central administration server and/or the central secure server, which will be included in the new bill of lading that is to be prepared, for example the outcome of a check of the freight container by the inspector. For this variant a central secured generator module is typically kept ready.

Another preferred variant provides that the secured generator module is operated by a first carrier who receives the provided freight container from the sender. The first carriers typically receive continuously a particularly large number of freight containers (for example more than 100 units per day), so that the acquisition costs and operating costs for a secured generator module can be split between numerous individual transport operations and thus remain low for the individual transport operation. Moreover, upon acceptance by the first carrier there is for the first time the necessity to prepare a bill of lading, so that the set-up of the generator module here avoids an unnecessary advance manipulation of the bill of lading.

In an advantageous variant an identification code is affixed to the freight container, in particular in the form of four letters and seven numbers, and the stored transport plan of the electronic freight container and the electronic bill of lading contain the identification code. This simplifies the assignment of the electronic bill of lading to the freight container.

Another variant that is advantageous provides that the electronic bill of lading following complete decryption can be printed out, but not the encrypted electronic bill of lading, in particular wherein the electronic bill of lading following complete decryption and transmission to the recipient in accordance with g) is printed out by the recipient. This prevents any misuse of the (encrypted) electronic bill of lading. The printed-out, completely-decrypted bill of lading does however allow the recipient to exploit the freight container and/or its contents in the usual manner. To improve security the completely-decrypted electronic bill of lading can be automatically deleted at the recipient after it has been printed out once on a printer of the recipient.

A preferred variant further provides that in step f) the sender checks whether he has received a specified payment for the freight container, and the sender releases the freight container for the recipient once he has received the specified payment,

in particular wherein an end device of the sender is set up such that the first key is automatically transmitted from the end device to the central secure server once the end device has automatically detected the receipt of the specified payment by the recipient. The specified payment is typically a money payment (for instance the purchase price), but may in individual cases also embrace a form of payment, such as in the form of goods. This variant can protect the sender from fraud or payment default. The automatic detection of the receipt of payment and automatic transmission of the first key through the end device of the sender in turn protects the recipient from fraud.

Preferred is a variant wherein one or more carriers transport the freight container by ship and/or by train and/or by truck and/or by plane. These transport modes enable large quantities of freight containers to be transported. It is preferred for at least one transport step for the freight container within the scope of the invention to be by ship.

Particularly preferred is a variant in which the sender and the recipient of the freight container and the one or more carriers and where applicable the at least one inspector communicate electronically through end devices, in particular PCs, tablets or smartphones, with the central administration server and/or the central secure server, and furthermore the secured generator module communicates electronically with the central administration server and/or the central secure server. The electronic communication is typically done via a data line that is internet-based or based on mobile communications. Typically all of the communications between the sender, the recipient, the one or more carriers, and at least one inspector on the one hand and the central administration server and/or the central secure server on the other hand are electronic.

The scope of the present invention also encompasses a computer system for the performance of a method according to the invention described above for the handling of a plurality of freight containers, comprising

a central secure server and a central administration server,

a plurality of secured generator modules, that can communicate electronically with the central secure server and/or the central administration server;

a plurality of end devices, in particular PCs, tablets or smartphones, that can communicate electronically with the central secure server and/or the central administration server, and which in each case are assigned to a sender or a recipient or a carrier or where applicable an inspector. The computer system can in particular be used in a method described above according to the invention. The electronic communication is typically done via the internet and/or a mobile radio network. The computer system according to the invention enables the exchange of goods by means of freight containers to be simplified and accelerated. In particular, document handling and communication can be organized with the computer system. Special software applications (apps) for communication with the central secure server and/or the central administration server are typically installed on the end devices.

A preferred embodiment of the computer system according to the invention provides that the secured generator modules are sealed, in particular wherein a resin sealing makes it impossible to open the respective casing of a secured generator module. This makes manipulations to the secured generator module more difficult or easier to identify.

Further advantages of the invention are provided in the description and in the drawing. Similarly, the above listed and further described features according to the invention can be used individually or in any desired combination. The embodiments shown and described are not to be understood as an exhaustive list, but instead are given by way of example for the description of the invention.

### BRIEF DESCRIPTION OF THE DRAWINGS

The invention is shown in the drawing and is described in more detail with reference to the example embodiments. The drawing is:

FIG. 1 is a schematic of a variant of the method according to the invention.

### DETAILED DESCRIPTION OF THE PREFERRED EMBODIMENTS

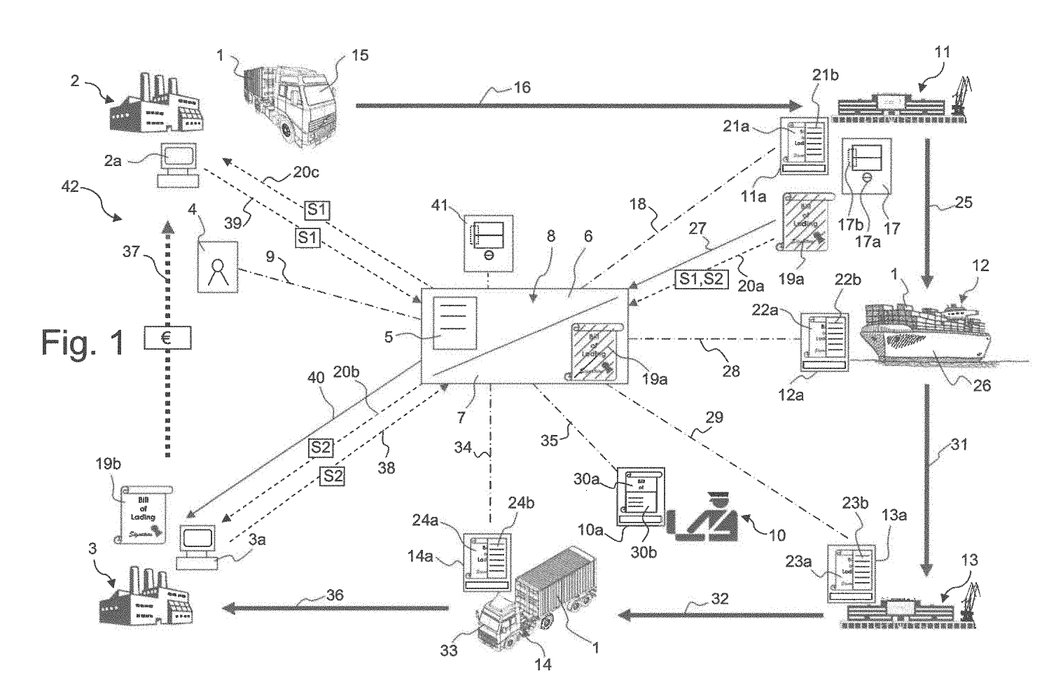

FIG. 1 shows, by way of example, a variant of the method according to the invention for handling of a freight container 1. A sender 2, in this instance a company that manufactures goods (for example gearing parts, not shown) wishes to send some manufactured goods in the freight container 1 to the recipient 3, here a company that processes the goods further (for example installs the gearing parts in automobiles and then sells the automobiles). The sender 2 and the recipient 3 have entered into a purchase agreement wherein the sender 2 must deliver the goods/the freight container 1 to the headquarters of the recipient 3, who will then check the goods and (if satisfactory) will pay the agreed purchase price to the sender 2. As soon as the goods have been paid for, the ownership of the goods, i.e. the contents of the freight container 1, is to be passed to the recipient 3.

The sender 2, in the variant of the method shown, has assigned the planning of the shipment of the freight container 1 to a forward carrier 4. This forward carrier 4 specifies the route of the freight container 1 from the sender 2 to the recipient 3 and in particular which further persons/bodies are to be involved. The forward carrier 4 prepares a transport plan 5, which is transmitted electronically to a central administration server 6 and is stored there 9.

The central administration server 6, together with the central secure server 7, is part of a central server system 8 that is responsible for a plurality of freight container transport operations (which in particular take place at the same time). For the transport of the freight container 1 considered here the central server system 8 is in electronic communication with the sender 2, the recipient 3, in this case an inspector 10 and here four carriers 11, 12, 13, 14, here via the internet. The sender 2 here has an end device 2a in the form of a PC (personal computer) and the end device 3a of the recipient 3 is also a PC. The inspector 10 and the carriers 11-14 here have tablets as their end devices 10a-14a. The first carrier 11 moreover has a secured generator module 17 here. In addition, the central server system 8 here also has a central secured generator module 41. The central administration server 6, the central secure server 7, the central secured generator module 41, as well as the end devices 2a, 3a, 10a-14a and secured generator modules 17 for all freight container transport operations form a computer system 42 according to the invention for performance of the method according to the invention.

The stored transport plan 5 contains information (such as the name, address and email address) of the envisaged carriers 11-14, the sender 2 and the recipient 3 and an envisaged inspector 10, and here furthermore handover points of time and handover locations for the freight container 1, as well as transport-relevant characteristics of the transported goods, for example type and quantity, and where necessary shelf life or hazards posed.

The planning of the forward planner 4 envisages that the sender 2 entrusts the freight container 1 to a first carrier 11, in this instance a port operator. At the premises of the sender 2 the goods are loaded into the freight container 1 and the freight container 1 is loaded onto a truck 15, and the freight container 1 is brought 16 to the first carrier 11 (note that the transport of the freight container 1 is indicated by a solid arrows in bold). The truck 15 may belong to the fleet of the sender 2, or to a haulage company that is reliable and that has been entrusted with providing the freight container 1 at the premises of the first carrier 11 (note that no formal bill of lading exists for this preliminary transport).

The first carrier 11 then prepares an encrypted bill of lading 19a by means of the secured generator module 17 (the hatching indicates encryption). The information required for the bill of lading can be derived from the transport plan 5 on the central administration server 6 after appropriate authentication of the first carrier 11/its secured generator module 17. Alternatively or in addition, information that the sender 2 makes directly available to the first carrier 11/its secured generator module 17 can be used (not shown). The bill of lading contains at least information on the carriers 11-14 involved in the transport of the bill of lading, if applicable on one or more inspectors 10, the sender 2 and the recipient 3. The bill of lading further typically contains an individualization code, an authentication characteristic (for example a seal or a code) and a freight container number as affixed to the outside of a freight container 1 (in most cases imprinted). The secured generator module 17 here has a closed casing and is secured by means of a lock 17a and has a seal 17b so that any unauthorized manipulation can be easily detected.

The encrypted bill of lading 19a is transmitted 27 to the central secure server 7 (compare thinner solid arrow) and is saved there; in contrast, no copy remains on the secured generator module 17 after it has been transmitted. The secured generator module 17 moreover generates two keys S1, S2, and the encrypted bill of lading 19a can be decrypted by the common use of both keys. These keys S1, S2 are transferred under the involvement of the central administration server 6 to the sender 2 and the recipient 3, see transmissions 20a, 20b, 20c (the dashed arrows indicate key transmissions). The sender 2 stores the first key S1 and the recipient 3 stores the second key S2; in contrast, no copies are stored on the secured generator module 17 and the central secure server module 8 after transmission. Without the keys S1, S2 a decryption of parts of the bill of lading 19a is possible, but not full decryption.

The first carrier 11 requests 18 from the central secure server system 8 a decrypted part 21a of the bill of lading 19a, to obtain legitimization for the further transport of the freight container. Since the first carrier 11 is listed and envisaged in the transport plan 5, he receives (after authentication against the central administration server 6) the requested part 21a from the central secure server 7/from the central server system 8 on his end device 11a. Together with the decrypted part 21a of the bill of lading 19a, it is possible to transmit parts (further information) 21b from the transport plan 5, for instance the handover point of time and the handover place for the freight container 1 to the second carrier 12.

This is then followed by the transport 25 of the freight container 1 from the first carrier 11 to the second carrier 12. The second carrier 12, here a shipping company with a ship 26, on which the freight container 1 has been loaded, authenticates against with the central administration server 6 and requests 28 for itself a decrypted part 22a of the bill of lading 19a, so that he can legitimize himself for the further transport of the freight container, as well as parts (further information) 22b from the transport plan 5. It is to be noted that this request is made typically some time before the handover of the freight container 1 to the second carrier 2.

In an analog manner the freight container 1 is transported 31 by the second carrier 12 to the third carrier 13, wherein the third carrier 13 is a port here. The third carrier 13 also authenticates himself and requests 29 a decrypted part 23a of the bill of lading 19a.

In the variant shown now an official control of the freight container 1 takes place by the inspector 10, in this cases the customs authorities of the country in which the port is located. The inspector 10 authenticates against with the central administration server 8 and requests 35 an unencrypted part 30a of the encrypted bill of lading 19a. It is to be noted that the part 30a above all contains information on any approvals by the authorities and on the freight itself, as well as information on the sender and recipient. In addition parts (further information) 30b from the transport plan 5 are transferred here too. If necessary in the course of the control or after it, the encrypted bill of lading 19a in use so far can be replaced by a new encrypted bill of lading (not shown) which is prepared by means of a central secured generator module 41 that is connected locally to the central server system 8. The keys S1, S2 now have to be replaced by new keys which have to be transmitted to the sender 2 and recipient 3 (not shown). The new encrypted bill of lading can in particular also contain information on the outcome of the control. It is to be noted that the control can in principle be carried out directly after transmission of the encrypted bill of lading 19a to the central secure server 7. In particular, the inspector does not need to wait for the arrival of a carrier.

If the control has been concluded successfully, the transport 32 of the freight container 1 to the fourth (and here last) carrier 14 can now take place. This fourth carrier 14 is a forwarding agent who loads the freight container 1 onto a truck 33. The fourth carrier 14 also authenticates itself and requests 34 an encrypted part 24a of the bill of lading 19a (and also parts 24b of the transport plan 5).

The fourth carrier 14 finally brings the freight container 1 to the recipient 3. The recipient 3 can authenticate against the central server system 8 and request a decrypted part 24a of the bill of lading 19a, in particular if the fourth carrier 14 should require legitimation for the delivery of the freight container 1 into the hands of the recipient 3 (not shown in detail).

The recipient 3 then checks the received freight container 1, in particular whether the goods contained therein are complete and in a proper condition. If he decides to accept the freight container 1/the goods, then the recipient 3 pays the sender 2 the agreed purchase price 37, here through transfer to a bank account specified by the sender 2. Similarly, the recipient 3 authenticates against the central administration server 6 and transmits his second key S2 to the central secure server 7, cf transmission 38.

The sender 2 monitors the receipt of the purchase price into his bank account. As soon as the agreed purchase price has been received, the sender authenticates against the central administration server 6 and transmits his first key S1 to the central secure server 7, cf transmission 39, to release the bill of lading 19a for decryption and transmission to the recipient 3, and through this to transfer ownership of the freight container/its contents. The monitoring of the receipt of payment and the release of the bill of lading by the sender 2 may be effected manually or automatically, for instance through suitable software applications on its end device 2a.

By means of the two keys S1, S2 the central secure server 7 now decrypts the encrypted bill of lading 19a. The completely decrypted bill of lading 19b is transmitted electronically 40 to the recipient 3, for example as a pdf file to its end device 3a, and is typically printed out by the recipient 3. The fully decrypted bill of lading 19b legitimizes the recipient 3 as the owner of the contents of the freight container 1, and thus as being entitled to take possession of the goods contained therein. The recipient 3 then, for example, installs the gearing parts in the freight container 1 into automobiles (not shown in detail).

It is to be noted that in one variant of the invention the complete decryption of the encrypted bill of lading 19a requires not just the concomitant usage of the two keys S1 and S2, but also the usage at the same time of at least one further key, for example a third key S3 (not shown). A further key can, for example, be kept ready by the operator of the central server system, to increase the security of the computer system 42. A further partner, contractually specified, which also participates in the trading of the freight container, for example a guarantor, may also receive a further key. The at least one further key is also generated by the secured generator module upon preparation of the encrypted bill of lading, and is transferred to a (respective) further person with responsibility for a key. The at least one further person with responsibility for a key is listed in the transport plan. For decrypting of the bill of lading the at least one person with responsibility for a key also has to authenticate against with the central administration server and transmit his key to the central secure server.

In summary, the invention relates to a method for the handling of a freight container (1) that is transported from a sender (2) via one or more carriers (11-14) to a recipient (3). An electronic bill of lading (19a) is generated for the freight container (1), by means of a secured generator module (17, 41) said bill of lading being stored in encrypted form on a central secure server (7). The sender (2) and the recipient (3) in each case receive an electronic key (S1, S2). The carriers (11-14) and where applicable inspectors (10) such as the customs authorities, can electronically request decrypted parts (21a-24a, 30a) of the electronic bill of lading (19a) via a data connection, in particular to show their authorization to further transport, or to inspect the freight container (1). If the recipient (3) is satisfied with the freight container (1) received he transmits his key (S2) electronically to the central secure server (7). The sender (2) electronically transmits his key (S1) to the central secure server (7) when he wishes to release the bill of lading (19a), in particular after he has received payment (37) of an agreed purchase price. Under joint use of the two keys (S1, S2) the encrypted electronic bill of lading (19a) can be decrypted on the central secure server and the decrypted electronic bill of lading (19b) is electronically transmitted to the recipient (3). The transfer of ownership to the recipient (3) is thereby completed. The invention simplifies and reduces the costs of exchanging goods by means of freight containers (1).

List of reference numbers

| | |
|---|---|
| 1 | Freight container |
| 2 | Sender |
| 2a | End device, here PC |
| 3 | Recipient |
| 3a | End device, here PC |
| 4 | Forward planner |
| 5 | Transport plan |
| 6 | Central administration server |
| 7 | Central secure server |
| 8 | Central server system |
| 9 | Storage of transport plan |
| 10 | Inspector |
| 10a | End device, here a tablet |
| 11 | First carrier |
| 11a | End device, here a tablet |
| 12 | Second carrier |
| 12a | End device, here a tablet |
| 13 | Third carrier |
| 13a | End device, here a tablet |
| 14 | Fourth carrier |
| 14a | End device, here a tablet |
| 15 | Truck |
| 16 | Providing of freight container |
| 17 | Secured generator module (first carrier) |
| 17a | Lock |
| 17b | Seal |
| 18 | Authentication/request |
| 19a | Encrypted bill of lading |
| 19b | Fully decrypted bill of lading |
| 20a | Transmission keys S1, S2 |
| 20b | Transmission key S2 |
| 20c | Transmission key S1 |
| 21a-24a | Decrypted parts of the bill of lading |
| 21b-24b | Parts of the transport plan |
| 25 | Transport of the freight container |
| 26 | Ship |
| 27 | Transmission of the encrypted bill of lading |
| 28 | Authentication/request |
| 29 | Authentication/request |
| 30a | Decrypted part of the bill of lading (inspector) |
| 30b | Parts of the transport plan (inspector) |
| 31 | Transport of the freight container |
| 32 | Transport of the freight container |
| 33 | Truck |
| 34 | Authentication/request |
| 35 | Authentication/request (inspector) |
| 36 | Transport of the freight container |
| 37 | Payment of the purchase price |
| 38 | Transmission of key S2 |
| 39 | Transmission of key S1 |
| 40 | Transmission of decrypted bill of lading |
| 41 | Secured generator module (central) |
| 42 | Computer system |
| S1 | First key |
| S2 | Second key |

What is claimed is:

1. A method for the handling of a freight container that is transported from a sender via one or more carriers to a recipient, the method comprising the steps of:
a) a sender providing a freight container, and preparing a transport plan for the freight container and storing the transport plan on a central administration server, wherein the transport plan lists at least the sender, one or more carriers and a recipient of the freight container;
b) preparing an encrypted electronic bill of lading using a secured generator module, wherein the encrypted electronic bill of lading can only be fully decrypted through the joint use of a first key and a second key, and wherein parts of the encrypted electronic bill of lading can be decrypted without the two keys;
c) transmitting the encrypted electronic bill of lading to a central secure server and storing the encrypted electronic bill of lading on that central secure server, and transmitting the first key to the sender of the freight container and transmitting the second key to the recipient of the freight container;
d) transporting the freight container via one or more carriers to the recipient, wherein:
each carrier authenticating against the central administration server and requesting a decrypted part of the bill of lading from the central secure server;
and if a check of the central administration server shows that the carrier is envisaged in the stored transport plan of the freight container then transmitting a decrypted part of the bill of lading to the carrier, by means of which the carrier can demonstrate that he is authorized to further transport the freight container;
e) the recipient checking the freight container, and if the recipient decides to accept it then the recipient authenticating against the central administration server and transmitting the second key to the central secure server;
f) if the sender decides to release the freight container for the recipient then the sender authenticating against the central administration server and transmitting the first key to the central secure server;
g) after the second key in step e) and the first key in step f) have been transmitted to the central secure server, decrypting the encrypted electronic bill of lading stored on the central secure server completely by means of those keys, and transmitting the completely decrypted electronic bill of lading to the recipient of the freight container, by means of which the recipient can demonstrate his entitlement to take possession of the contents of the freight container.

2. The method according to claim 1, wherein the secure generator module authenticates the electronic bill of lading upon its preparation, clearly labels it and encrypts it.

3. The method according to claim 1, wherein the respective carrier in step d) receives in addition to the part of the bill of lading also a part of the stored transport plan, comprising information on a prior carrier and/or a next carrier and/or handover times and/or handover locations.

4. The method according to claim 1, wherein the encrypted electronic bill of lading after its transmission to the central secure server in step c) is removed from the secured generator module.

5. The method according to claim 1, wherein the first and second keys after their transmission in step c) are removed from the secured generator module and where applicable from the central administration server.

6. The method according to claim 1, wherein the electronic bill of lading after its complete decryption and transmission to the recipient in step g) is deleted from the central secure server.

7. The method according to claim 1, wherein for the preparation of the encrypted electronic bill of lading the secured generator module receives information from the transport plan stored on the central administration server.

8. The method according to claim 1, wherein the stored transport plan of the freight container or the central administration server lists at least one inspector for a large number of transport plans, including the stored transport plan of the freight container, that during step d) an inspector authenticates against the central administration server and requests a decrypted part of the bill of lading, and if a check of the central administration server shows that the inspector is envisaged in the stored transport plan of the freight container or in the central administration server for a large number of transport plans, including the stored transport plan of the freight container, then a decrypted part of the bill of lading is transmitted to the inspector.

9. The method according to claim 8, wherein following transmission of the decrypted part to the inspector the existing electronic bill of lading for the freight container is deleted and is replaced for the further method by a new electronic bill of lading for the freight container, which is stored in encrypted form on the central secure server, wherein for the new encrypted electronic bill of lading a new first key is transmitted to the sender and a new second key is transmitted to the recipient.

10. The method according to claim 1, wherein the secured generator module is operated by a first carrier who receives the provided freight container from the sender.

11. The method according to claim 1, wherein an identification code is affixed to the freight container, and the stored transport plan of the freight container and the electronic bill of lading contain the identification code.

12. The method according to claim 11, wherein the identification code is in the form of four letters and seven numbers.

13. The method according to claim 1, wherein the electronic bill of lading following complete decryption can be printed out, but not the encrypted electronic bill of lading, and wherein the electronic bill of lading following its complete decryption and transmission to the recipient in accordance with step g) is printed out by the recipient.

14. The method according to claim 1, wherein in step f) the sender checks whether he has received a specified payment for the freight container, and the sender releases the freight container for the recipient once he has received the specified payment, wherein an end device of the sender is set up such that the first key is automatically transmitted from the end device to the central secure server once the end device has automatically detected receipt of the specified payment by the sender.

15. The method according to claim 1, wherein the one or more carriers transport the freight container by ship and/or by rail and/or by truck and/or by plane.

16. The method according to claim 1, wherein the sender and the recipient of the freight container and the one or more carriers and where applicable the at least one inspector communicate electronically through end devices with the central administration server and/or the central secure server, and furthermore the secured generator module communicates electronically with the central administration server and/or the central secure server.

17. A computer system for the performance of the method according to claim 1 for the handling of a plurality of freight containers, comprising:
a central secure server and a central administration server;
a plurality of secured generator modules that can communicate electronically with the central secure server and/or the central administration server;
a plurality of end devices that can communicate electronically with the central secure server and/or the central administration server, and which in each case are assigned to a sender or a recipient or a carrier or where applicable an inspector.

18. The computer system according to claim 17, wherein the secured generator modules are sealed.

19. The computer system according to claim 18, wherein a resin seal makes it impossible to open the casing of a respective secured generator module.

20. The computer system according to claim 17, wherein the end devices comprise PCs, tablets or smartphones.
